(19) United States
(12) Patent Application Publication
(10) Pub. No.: US 2008/0173254 A1
(43) Pub. Date: Jul. 24, 2008

(54) Equine trainer and exerciser

(76) Inventors: Ivan Ibert Townsend, Cocoa, FL (US); Michael Bert Townsend, Cocoa, FL (US)

Correspondence Address: IVAN IBERT TOWNSEND, III;MICHAEL AND BERT TOWNSEND, 3440 ORLEANS STREET, COCOA, FL, 32926, US

(21) Appl. No.: 11/626,765

(22) Filed: Jan. 24, 2007

(51) Int. Cl. A01K 15/02

(52) U.S. Cl. 119/701

(57) ABSTRACT

An animal exercising and training mechanism designed to lunge or guide an equine in a circular path without the trainer having to hold the lunge line to do so. The trainer is able to lunge the equine without being exposed to the constant tension on the lunge line and enjoy hands free training. The Equine Exerciser/Trainer would consist of a vertical pole approximately 10 feet long extending approximately 7 feet above ground elevation and mounted approximately 3 feet into the ground with a concrete base or other securing methods, and a bearing mounted, free rotating horizontal bar (Swivel Arm) attached to the top of the vertical pole approximately 3 feet long. A lunge line would be attached from the end of the Equine Exerciser/Trainer's Swivel Arm to a head restraint device of the animal being exercised or trained. The Equine Exerciser/Trainer would guide the equine in a circle as if a person were holding the line himself but the equine would actually be secured to the Equine Exerciser/Trainer thus limiting the equine to the radius defined by the length of the lunge line and Swivel Arm.

### BACKGROUND OF INVENTION

Lunging is a very common exercise for equines. It involves the equine being sent around the owner in circles on the end of a rope or lunge line. Many people use lunging for animal exercise and to teach the equine to move in a better frame. Lunging is a useful way to exercise an equine prior to riding to warm up the equine and in many cases, as a method to allow the equine to work out any playfulness or aggression prior to the rider mounting the equine. Many bucking and other undesirable equine behaviors can be avoided by lunging an animal prior to mounting, making the riding or training experience safer and less time consuming for the animal as well as the rider.

The main problem with lunging or teaching an equine to be led around is that equines sometimes pull back on the handler and since the equine is much stronger, the handler can be over powered. Lunging can also be physically exhausting for the trainer as he/she is under constant strain from the lunge line tension and is forced to pass the rope around his/her body or rotate with the animal.

### BRIEF SUMMARY OF THE INVENTION

The Equine Trainer and Exerciser is designed to make the task of lunging, safer, easier, to eliminate the need for lunging arenas, and to be more beneficial than conventional lunging methods. The Equine Exerciser/Trainer could aid in teaching gates and lead changes with hands free operation it can control even the most defying equines and exercise them with little effort by the handler. Those equine handlers with physical limitations such as size or mobility would be more capable of exercising their animals with the use of the Equine Exerciser/Trainer.

If done properly and gradually increased in duration, the Equine Exerciser/Trainer can strengthen an equine's musculature, improve its impulsion, tracking, bending, balance, and rhythm.

### BRIEF DESCRIPTION OF SEVERAL VIEWS OF THE DRAWING

FIG. 1: Showing a vertical support structure with the lower end inserted into the ground then concreted and the vertical support structure upper end supporting the horizontal swivel arm used to guide the equine in a circular path

FIG. 1: Showing an eye bolt or loop on the swivel arm as a means for attaching a lunge line from this attachment eye to the halter of an equine.

FIG. 2: Showing swivel mechanism mounted on the top of the support structure shown in FIG. 1 having a means for a freely rotating swivel arm.

### DETAILED DESCRIPTION OF THE INVENTION

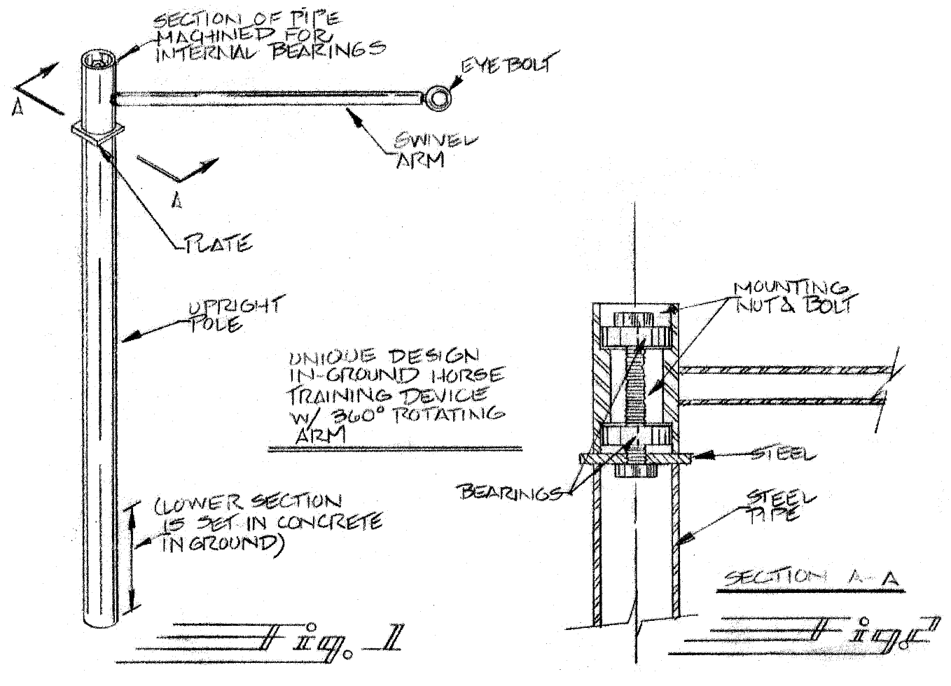

The device is a free standing vertical pole with a horizontal rotating swivel arm (FIG. 1) on top that guides an equine in a circle for the purpose of getting inexperienced equines to accept having their heads guided by humans, and as a general exercise and training mechanism. The Equine Exerciser/Trainer allows a trainer to seemingly physically lead an equine in a circular path but the equine is actually secured to the swivel arm of the Equine Exerciser/Trainer. The equine may attempt to pull free from the handler but is not able to because it is actually tied to a rigid structure instead. This device allows the equine to be lunged without the trainer having to be exposed to the constant lunge line tension.

This device can be used as a daily training and exercising tool by almost everyone who has dealings with equines. It is much less expensive than a training pen and less expensive and more versatile than the common motorized equine walking device.

The equine is wearing a normal halter and is attached to the free standing pole's Tether Eye on the Swivel Arm using a normal equine lead line. The handler stands near the free standing pole base then encourages the equine to run away from the handler. The equine will naturally move away in a straight line but the lead line attached to the freely rotating hub will guide the equine in a circle around the trainer.

### Assembly:

The lower section of the vertical support structure is set in concrete or supported such that it is a rigid structure as shown in FIG. 1.

A swivel arm is fabricated such that a lunge line can be attached as shown in FIG. 1.

The Swivel Arm is secured to the vertical support structure such that the Swivel arm is free to rotate around a vertical axis as shown in FIG. 2.

What is claimed is:

1. An equine exercising and training apparatus comprising: A vertical pole or support structure with a horizontal guide arm free to rotate around a vertical axis designed to guide an equine or self propelled body in a circular path.

2. The exercising and training apparatus in claim 1 wherein the horizontal guide arm is bearinged or supported such that the horizontal arm is free to rotate about a vertical axis

3. The exercising and training apparatus in claim 1 wherein the horizontal arm referenced in claim 2 has an attachment point to receive a lunge line from an equine's halter or other restraint device.

4. The equine referenced in claim 3 is forced to move in a circular pattern as the lunge line referenced in claim 3 is kept taut by the equine.
